(19) United States
(12) Patent Application Publication
(10) Pub. No.: US 2005/0128866 A1
(43) Pub. Date: Jun. 16, 2005

(54) Medicinal package mixing device

(76) Inventor: I-Ya Su, Taipei (TW)

Correspondence Address: BACON & THOMAS, PLLC, 625 SLATERS LANE, FOURTH FLOOR, ALEXANDRIA, VA, 22314, US

(21) Appl. No.: 10/992,742

(22) Filed: Nov. 22, 2004

(30) Foreign Application Priority Data
Dec. 11, 2003 (TW) 92135097

(51) Int. Cl. B01F 3/12

(52) U.S. Cl. 366/130; 206/219

(57) ABSTRACT

A medicinal package mixing device having a first side wall forming a first containment space, one or a plurality of second side walls forming one or a plurality of second containment space or spaces disposed in the first containment space formed by the first side wall, the device is characterized in that: each second side wall is made of a breakable material so that the second containment space can be connected to the first containment space by breaking the second side wall.

### BACKGROUND OF THE INVENTION

1. Field of the Invention

The present invention relates to a medicinal package mixing device and, more particularly, to a medicine package for both a medicine and a solution that are packed separately, and which by pressing the package are mixed together.

2. Description of the Related Art

In the traditional preparation method for mixing a medicine and a solution for injection, the medicine and the solution are both pulled into a container to be stirred and mixed evenly, and then the mixture is pulled into a syringe for injection.

However, this is a very complicated process, and it is difficult to accurately measure the medicine and the solution, and to evenly mix them together. Furthermore, when the mixture is ready to be pulled into the syringe, it may be accidentally spilled.

Therefore, it is desirable to provide a medicinal package mixing device to mitigate and/or obviate the aforementioned problems.

### SUMMARY OF THE INVENTION

A main objective of the present invention is to provide a medicinal package mixing device.

Another objective of the present invention is to provide a medicinal package mixing device having a first side wall and one or a plurality of second side walls separately forming a first containment space and one or a plurality of second spaces for containing a medicine or solution, and the second containment space is placed in the first containment space.

Another objective of the present invention is to provide a medicinal package mixing device with a plurality of second side walls made of breakable material.

Another objective of the present invention is to provide a medicinal package mixing device having an outlet, which is closed by a breakable material, the outlet disposed next to one or a plurality of tubes, and the first containment space can be broken to communicate with the tubes.

The medicinal package mixing device has a first side wall forming a first containment space, one or a plurality of second side walls forming one or a plurality of second containment spaces that are disposed within the first containment space formed by the first side wall, and the device is characterized in that each second side wall is made of a breakable material so that the second containment space can communicate with the first containment space by breaking the second side wall by squeezing.

In the medicinal package mixing device, each second side wall can be connected to the first sidewall in the first containment space, or moveably disposed in the first containment space.

In the medicinal package mixing device, the first side wall has an outlet, which is closed by a breakable material.

In the medicinal package mixing device, the outlet of the first side wall is connected to one or a plurality of tubes, and the first containment space can communicate with the one or a plurality of tubes by breaking the outlet by squeezing the first side wall.

In the medicinal package mixing device, the side walls are made of a flexible and deformable material, which is lightly melted to adhere with a high frequency device, an ultrasonic device or a hot melting device, and is gently stuck together by the machine so that the side walls can be broken under pressure to mix the medicine and the solution separated by the side walls.

In the medicinal package mixing device, the outlet of the first side wall is loosely sealed at the end next to the containment space but is a fixed joint, a moveable socket joint or a threaded joint to connect with the outlet of the first packaging bulb.

In the medicinal package mixing device, the tubes can be singular and hollow tubes, or a syringe, or connected to another medical device.

In the medicinal package mixing device, the first containment space and the second containment space are used to contain a medicine or a solution, and can be easily broken by an external force to mix together the medicine and the solution, and this even mixture can be pressed through the tube.

In the medicinal package mixing device, the medicine can be a powder, in a pill for, or another form, and the medicine and the solution can be filled with a predetermined amount for a perfect mixture.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a medicinal package mixing device according to the present invention.

FIG. 2 is a side view of the medicinal package mixing device according to the present invention.

FIG. 3 is an application schematic drawing of the medicinal package mixing device according to the present invention.

### DETAILED DESCRIPTION OF THE PREFERRED EMBODIMENT

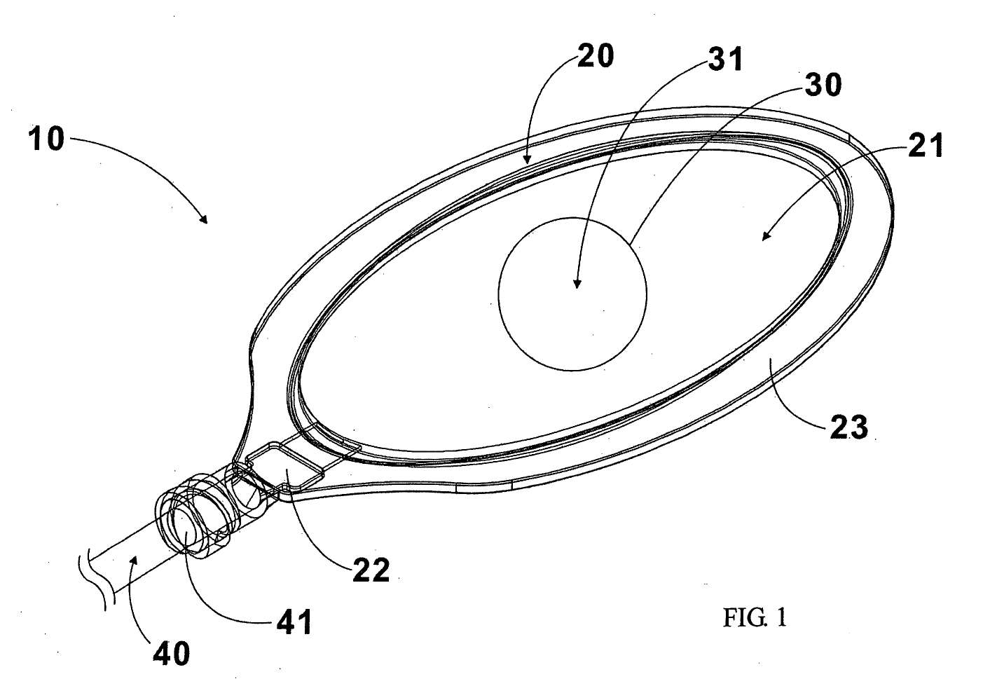

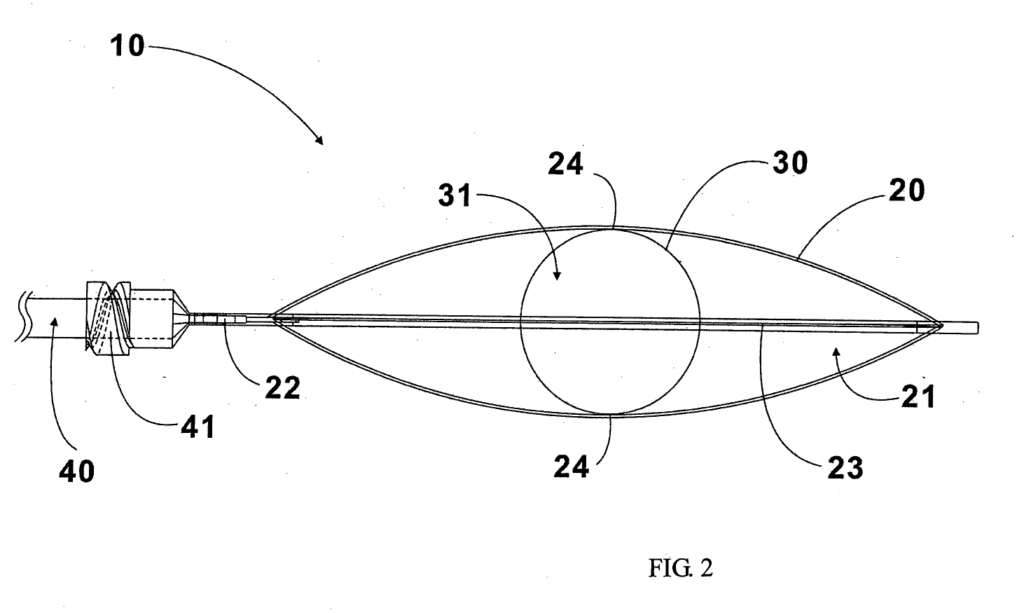

Please refer to FIG. 1 and FIG. 2. A medicine package mixing device 10 comprises a first packaging bulb 20 (a first side wall), a first containment space 21 formed by the first a first packaging bulb 20, and an outlet 22 disposed on the first packaging bulb 20. The first packaging bulb 20 bounds the first containment space 21 by a periphery 23, which is completely and tightly sealed except at the outlet 22. The periphery 23 is loosely sealed by a high frequency or hot melting device at the outlet 22. Therefore, when the first space 21 formed by the first side wall 20 made of a breakable material is pressed by an external force, the outlet 22 will be broken from the medicine in the first containment space.

The medicinal package mixing device 10 further comprises a second packaging bulb (a side wall) 30, and a second containment space 31 formed by the second packaging bulb 30. The second side wall 30 is also loosely sealed by a high frequency or hot melting device, and a thickness and material of the second side wall 30 is breakable under an externally applied force. A medicine or solution fills the second containment space 31 of the second packaging bulb 30, and the second packaging bulb may be fixedly or moveably disposed within the first containment space 21 of the first packaging bulb 20.

In an embodiment of the present invention, a medicinal powder or pill fills the first containment space 21 of the first packaging bulb 20, and a solution fills the second containment space 31 of the second packaging bulb 30. When a user wants to use the medicinal package mixing device 10, he or she presses the second packaging bulb 30 to break the loose seal so that the solution in the second containment space 31 flows into the first containment space to mix with the medicine. Then, the user massages the first containment space 21 to evenly mix the medicine and the solution, and then squeezes the mixture to the outlet 22, or utilizes a crimping device to clamp the first side wall 20 to completely ueeze the mixture out.

The medicinal package mixing device 10 further comprises a tube 40, which utilizes a fixed joint, a moveable socket joint or a threaded joint to connect with the outlet 22 of the first packaging bulb 20, and the mixture can be sent to any predetermined position via the tube 40.

In FIG. 2, a contact region 24 of the first side wall 20 and the second side wall 30 can be firmly or moveably connected together. Furthermore, one or a plurality of second packaging bulbs 30 may be provided.

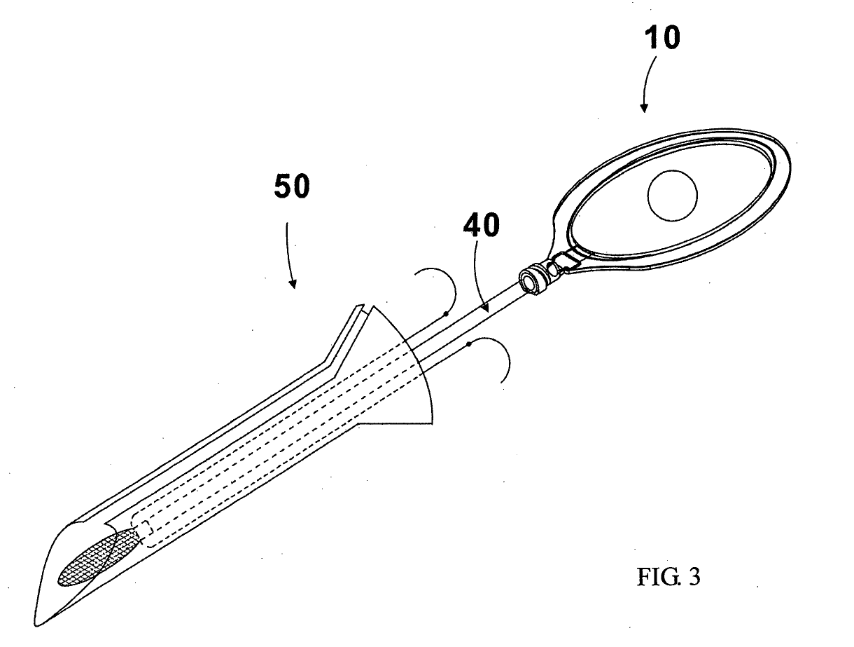

In FIG. 3, after the medicinal package mixing device 10 is loaded with the medicine and solution, the medicinal package mixing device 10 can be connected with an artificial tender device 50, and the tube 40 can be a part of the artificial tender device 50, or may be a part of another medical device.

Although the present invention has been explained in relation to its preferred embodiment, it is to be understood that many other possible modifications and variations can be made without departing from the spirit and scope of the invention as hereinafter claimed.

1. A medicinal package mixing device having a first side wall forming a first containment space, one or a plurality of second side walls forming one or a plurality of second containment space or spaces disposed in the first containment space formed by the first side wall, the device being characterized in that:
each second side wall is made of a breakable material so that the second containment space can be communicated with the first containment space by breaking the second side wall by squeezing.

2. The medicinal package mixing device as claimed in claim 1, wherein each second side wall is connected to the first sidewall in the first containment space, or is moveably disposed in the first containment space.

3. The medicinal package mixing device as claimed in claim 1, wherein the first side wall has an outlet that is sealed with a breakable material.

4. The medicinal package mixing device as claimed in claim 3, wherein the outlet is connected to one or a plurality of tubes, and the first containment space can communicate with the one or a plurality of tubes by breaking the outlet by squeezing the first side wall.
